(19) United States
(12) Patent Application Publication
(10) Pub. No.: US 2012/0196109 A1
(43) Pub. Date: Aug. 2, 2012

(54) SURFACE NUCLEATED GLASS CERAMICS FOR TV COVER GLASS

(76) Inventors: Sasha Marjanovic, Painted Post, NY (US); Pamela Arlene Maurey, Savona, NY (US); Daniel Aloysius Nolan, Corning, NY (US)

(21) Appl. No.: 13/212,587

(22) Filed: Aug. 18, 2011

Related U.S. Application Data
(60) Provisional application No. 61/378,426, filed on Aug. 31, 2010.

(51) Int. Cl. B32B 17/06; B32B 33/00; C03C 14/00

(52) U.S. Cl. 428/220; 428/410; 428/428; 428/332

(57) ABSTRACT

Surface nucleated glass ceramics for television cover glass applications. The glass ceramic may include lithium alumina silicate compositions. The glass ceramics may be ion-exchanged or chemically strengthened.

This application claims the benefit of priority under 35 U.S.C. §119 of U.S. Provisional Application Ser. No. 61/378,426 filed on Aug. 31, 2010 the content of which is relied upon and incorporated herein by reference in its entirety.

### BACKGROUND

1. Field

Embodiments of the invention relate to surface nucleated glass ceramics and more particularly to surface nucleated glass ceramics useful for, for example, television (TV) cover glass.

2. Technical Background

Surface crystallization or surface nucleation methods for glass strengthening were invented in Corning Incorporated by Stanley D. Stookey in the late nineteen fifties. Later, the idea of glass strengthening by developing a surface crystalline layer was spread and studied through both academic and industrial communities.

Additional work by Corning Incorporated continued. The goals of the work mentioned were glasses that would be strengthened by developing a surface crystalline layer, while remaining transparent. Interestingly, some compositions that contained TiO₂ resulted in the creation of colored glassware.

Typically when making surface crystallized glass ceramics such as lithium alumina-silicates, the glasses are melted and formed in a conventional way. Later, they are heat treated to promote surface crystallization. With controlled heat treatments, the glass can remain pristine below the surface, while overall glass transparency depends on the thickness of the crystalline layer. Further, the glass ceramics can be fully crystalline. Compressive stresses are generated at the glass ceramic surface upon cooling, therefore making strong glass ceramics, sometimes in excess of 700 MPa of flexural strength. There are some challenges associated with the process. For example, high temperature heat treatments are needed, deformation is common, transparency is quite challenged, and fundamental understanding of the process itself is still not complete.

It would be advantageous to have a TV cover glass which can affect the scattering of light and provide strength in this application.

### SUMMARY

Surface nucleated glass ceramics for TV cover glass applications as described herein, may have one or more of the following advantages: the surface crystalline layer of the surface nucleated glass ceramic may be used to manipulate the scattering of light from such surface by growing crystals of various sizes and layer thicknesses and/or increased strength.

Such glass may be used as TV cover glass that can provide illumination when the TV is switched off. High glass strength comes as an additional benefit for TV cover glass applications. Conventional glass strengthening methods involve ion exchange processes. Surface nucleated glass ceramics offer glass strength similar to those achieved by ion exchange, but potentially at a lower cost. If needed, the surface nucleated glass ceramics could be ion exchanged for additional strength improvement.

One embodiment is a cover glass for a television comprising a glass ceramic comprising a surface nucleated portion.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawings.

FIG. 1 is a cross sectional scanning electron microscope (SEM) image of a glass ceramic, according to one embodiment.

FIG. 2 is a top view down scanning electron microscope (SEM) image of the surface nucleated glass ceramic, according to one embodiment.

FIG. 3 is a transmittance spectral plot showing total and diffuse transmittance vs. wavelength of an exemplary glass ceramic.

FIG. 4 is a plot of haze (diffuse or total transmittance ratio) for an exemplary glass ceramic.

FIG. 5 is a plot of the angular scattering of an exemplary glass ceramic.

### DETAILED DESCRIPTION

Reference will now be made in detail to various embodiments of the invention, an example of which is illustrated in the accompanying drawings.

As used herein, the term “planar” can be defined as having a substantially topographically flat surface.

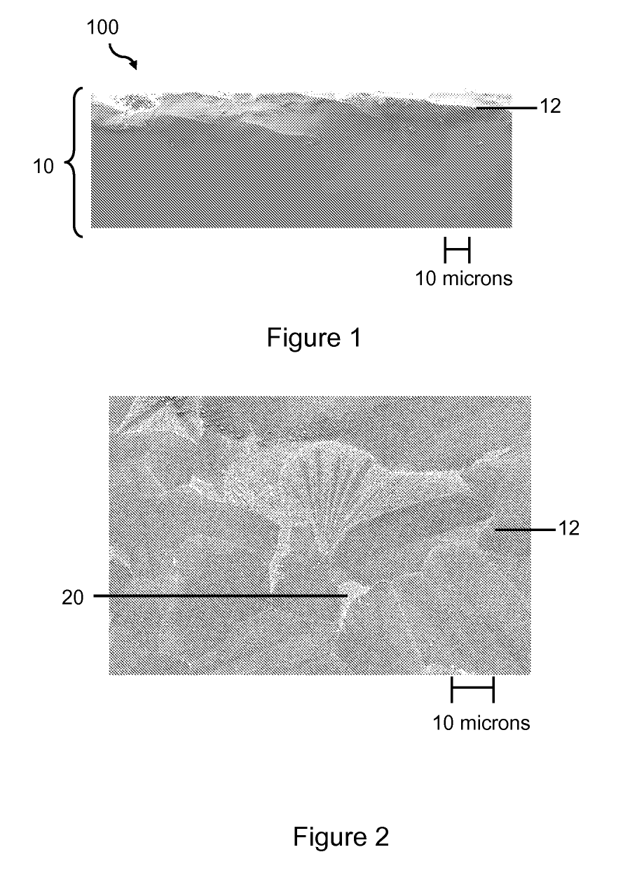

One embodiment as shown in FIG. 1 is a cover glass 100 for a television comprising a glass ceramic 10 comprising a surface nucleated portion 12.

In one embodiment, the surface nucleated portion has an average thickness of from 30 microns to 150 microns.

According to some embodiments, the glass ceramic comprises two or more surface nucleated portions.

According to one embodiment, the glass ceramic comprises two surface nucleated portions, one located at the first surface and another located at the second surface of the sheet.

The glass ceramic, in one embodiment, comprises a zinc doped lithium alumina silicate.

High material strength is advantageous for tv cover glass. Surface nucleated glass ceramics offer strength almost similar to those achieved by ion exchange, but at much lower cost. If needed, these glass ceramics can be ion exchanged for additional strength improvement. In some embodiments, the glass ceramic is ion exchanged.

According to one embodiment, the glass ceramic is ion exchanged in a salt bath comprising one or more salts of alkali ions. The glass ceramic can be ion exchanged to change its mechanical properties. For example, smaller alkali ions, such as lithium or sodium, can be ion-exchanged in a molten salt containing one or more larger alkali ions, such as sodium, potassium, rubidium or cesium. If performed at a temperature well below the strain point for sufficient time, a diffusion profile will form in which the larger alkali moves into the glass ceramic surface from the salt bath, and the smaller ion is moved from the interior of the glass ceramic into the salt bath. When the sample is removed, the surface will go under compression, producing enhanced toughness against damage. A large alkali already in the glass ceramic can also be exchanged for a smaller alkali in a salt bath. If this is performed at temperatures close to the strain point, and if the glass is removed and its surface rapidly reheated to high temperature and rapidly cooled, the surface of the glass ceramic will show considerable compressive stress introduced by thermal tempering. It will be clear to one skilled in the art that any monovalent cation can be exchanged for alkalis already in the glass ceramic, including copper, silver, thallium, etc., and these also provide attributes of potential value to end uses, such as introducing color for lighting or a layer of elevated refractive index for light trapping.

In one embodiment, the glass ceramic is planar. The first surface and/or the second surface is substantially topographically flat, in one embodiment. In another embodiment, both surfaces are substantially topographically flat.

The surface nucleated glass ceramic, in one embodiment, comprises glass ceramics comprising lithium alumina-silicate compositions, which have high strength after heat treatment, since compressive stresses are generated by the crystals at the glass ceramic surface upon their cooling. In one embodiment, the composition is doped with fluorine, chlorine, zinc, or combinations thereof. The composition, in one embodiment, comprises in mole percent: 60 to 70 SiO₂, 10 to 20 Al₂O₃, and 5 to 15 Li₂O. The composition can further comprise greater than 0 to 20 percent RO, wherein R is an alkaline earth metal. In one embodiment, R is Ca, Mg, or a combination thereof. In one embodiment, the composition further comprises greater than 0 to 10 percent M₂O, wherein M is an alkali metal. According to one embodiment, M is Na. Exemplary compositions in mole percent are found in Table 1.

TABLE 1

| Oxide | 1 | 2 | 3 | 4 | 5 | 6 | 7 | 8 | 9 | 10 |
|---|---|---|---|---|---|---|---|---|---|---|
| SiO₂ | 62.23 | 62.2 | 65.36 | 64.13 | 67.82 | 68.82 | 62.23 | 62.23 | 62.23 | 62.23 |
| Al₂O₃ | 13.18 | 16.3 | 15.10 | 16.20 | 15.49 | 14.38 | 13.18 | 13.18 | 13.18 | 13.18 |
| Li₂O | 6.84 | 14.6 | 13.31 | 13.25 | 12.33 | 12.44 | 6.84 | 6.84 | 6.84 | 6.84 |
| ZnO | 5.61 | 3.46 | 4.7 | 3.27 | 3.41 | 3.41 | 5.61 | 5.61 | 5.61 | 4.61 |
| MgO | 12.14 | 0 | 0 | 0 | 0 | 0 | 12.14 | 12.14 | 12.14 | 11.14 |
| CaO | 0 | 2.83 | 0 | 1.69 | 0.1 | 0.1 | 0 | 0 | 0 | 0 |
| Na₂O | 0 | 0.61 | 1.53 | 1.01 | 0 | 0 | 0 | 0 | 0 | 0 |
| B₂O₃ | 0 | 0 | 0 | 0.45 | 0.85 | 0.85 | 0 | 0 | 0 | 0 |
| F⁻ | 0 | 0 | 0 | 0 | 0 | 0 | 2 | 0 | 1 | 0 |
| Cl⁻ | 0 | 0 | 0 | 0 | 0 | 0 | 0 | 2 | 1 | 1 |

The temperature and the length of the heat treatments can control the overall transparency, which depends on the thickness of the grown crystalline layer, while glass remains pristine bellow the crystallized surface. The size of the crystals grown at the glass surface and the thickness of such crystal layer can manipulate and scatter the incoming light. This could scatter light from, for example, light-emitting diode (LED) lights when a television is turned off.

A cross sectional scanning electron microscope (SEM) image of a cover glass 100 for a television comprising a glass ceramic 10 comprising a surface nucleated portion 12, according to one embodiment is shown in FIG. 1.

A top view down scanning electron microscope (SEM) image of the surface nucleated portion 12, according to one embodiment is shown in FIG. 2.

In both FIG. 1 and FIG. 2 the surface nucleated portion shown was after 4 hrs heat treatment at 800° C. of exemplary glass ceramic 1 from Table 1.

The glass ceramic can be used to manipulate the scattering of light from the surface nucleated portion. Crystals of various sizes within the surface nucleated portion can be used to affect the light scattering of the TV cover glass.

In one embodiment, the average thickness of the glass ceramic is 3.2 millimeters (mm) or less, for example, from 0.7 millimeters to 1.8 millimeters. In one embodiment, the surface nucleated portion has an average thickness of 250 microns or less, for example, greater than zero to 250 microns, for example, from 10 microns to 250 microns, for example, from 15 microns (μm) to 250 microns. In one embodiment, the surface nucleated portion has an average thickness of 150 microns or less, for example, greater than zero to 150 microns, for example, from 10 microns to 150 microns, for example, from 15 microns (μm) to 150 microns.

In one embodiment, the surface nucleated portions when there is more than one present have a total average thickness of 250 microns or less, for example, greater than zero to 250 microns, for example, from 10 microns to 250 microns, for example, from 15 microns (μm) to 250 microns. In one embodiment, the surface nucleated portions have an average thickness of 150 microns or less, for example, greater than zero to 150 microns, for example, from 10 microns to 150 microns, for example, from 15 microns (μm) to 150 microns.

In one embodiment, the glass ceramic is not fully crystalline. In another embodiment, the glass ceramic is 90 percent crystalline or less, for example, greater than zero percent to 90 percent crystalline. There is a layer of amorphous glass. In some embodiments, there are two surface nucleated portions sandwiching the amorphous glass.

FIG. 10 is a transmittance spectral plot showing total, line 14, and diffuse, line 16, transmittance vs. wavelength of a glass ceramic having two surface nucleated portions having a total average thickness of 30 μm (15 μm average thickness for each surface nucleated portion).

FIG. 4 is a plot of haze shown by line 18 (diffuse or total transmittance ratio) for an exemplary glass ceramic.

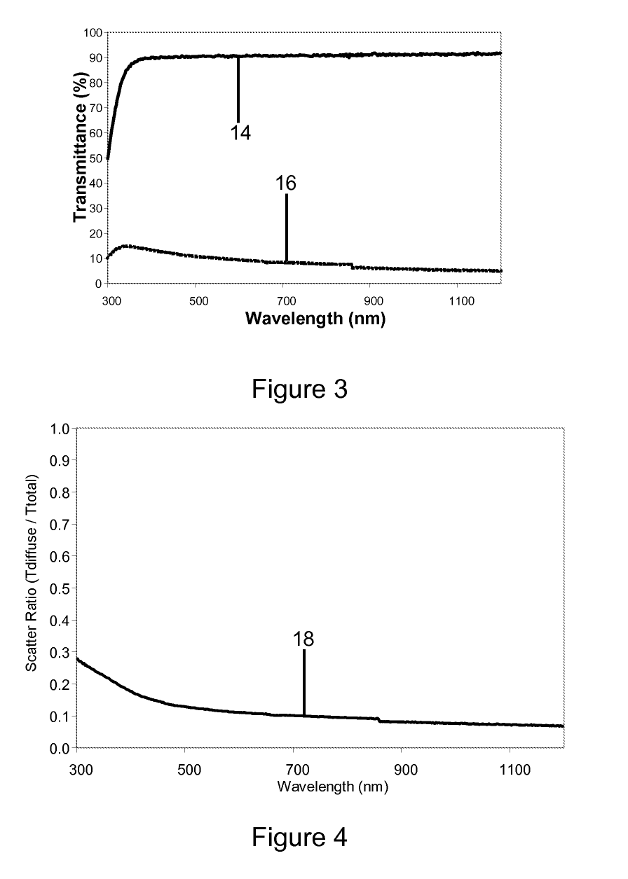

Light scattering results are shown in FIGS. 3 and 4. Both transmittance and haze results are very satisfactory for TV cover glass applications, since both high total transmittance and low haze are advantageous. The addition of fluorine and chlorine led to changes in heat treatment conditions and offered additional control for surface crystal growth. Representative glass compositions are presented in Table 1. High strength of the glass ceramics described herein may satisfy the additional requirement for TV cover glass to be able to withstand impacts.

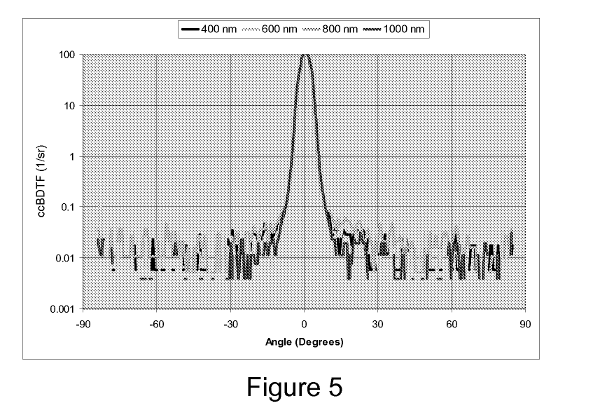

The surface nucleated glass ceramics can contain small (around 1 micron) and larger (around 10 micron) scattering sites. This can provide a good angularly independent scattering. The small sites give a nearly angularly independent scattering which then enables nearly angularly independent viewing of the illuminated TV cover glass screen. This is shown in FIG. 5 which is a plot of the angular scattering at 400 nm, 600 nm, 800 nm, and 1000 nm of an exemplary glass ceramic. In the cover glass, according to some embodiments, the glass ceramic comprises nucleated sites less than four times the wavelength of an illuminating source, for example, one or more LED lights. For example, for a 0.5 micron wavelength source, the nucleated sites, feature 20 in FIG. 2, should optimally be less than 2 microns in the linear length.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A cover glass for a television comprising a glass ceramic comprising a surface nucleated portion.

2. The cover glass according to claim 1, wherein the glass ceramic is ion exchanged.

3. The cover glass according to claim 1, wherein the glass ceramic comprises a lithium alumina silicate composition.

4. The cover glass according to claim 3, wherein the composition is doped with fluorine, chlorine, zinc, or combinations thereof.

5. The cover glass according to claim 4, wherein the composition comprises in mole percent: 60 to 70 SiO₂, 10 to 20 Al₂O₃, and 5 to 15 Li₂O.

6. The cover glass according to claim 5, further comprising greater than 0 to 20 percent RO, wherein R is an alkaline earth metal.

7. The cover glass according to claim 6, wherein R is Ca, Mg, or a combination thereof.

8. The cover glass according to claim 5, further comprising greater than 0 to 10 percent M₂O, wherein M is an alkali metal.

9. The cover glass according to claim 8, wherein M is Na.

10. The cover glass according to claim 1, wherein the glass ceramic is in the form of a sheet.

11. The cover glass according to claim 10, wherein the sheet is planar.

12. The cover glass according to claim 10, wherein the glass ceramic comprises two surface nucleated portions, one located at the first surface and another located at the second surface of the sheet.

13. The cover glass according to claim 10, wherein the surface nucleated portions have a total average thickness 250 microns or less.

14. The cover glass according to claim 1, wherein the surface nucleated portion has an average thickness of 250 microns or less.

15. The cover glass according to claim 1, comprising two or more surface nucleated surface portions.

16. The cover glass according to claim 1, wherein the average thickness of the glass ceramic is 3.2 millimeters or less.

17. The cover glass according to claim 16, wherein the average thickness of the glass ceramic is from 0.5 millimeters to 1.8 millimeters.

18. The cover glass according to claim 1, wherein the glass ceramic comprises nucleated sites less than four times the wavelength of an illuminating source.
